(19) United States
(12) Patent Application Publication
(10) Pub. No.: US 2026/0124873 A1
(43) Pub. Date: May 7, 2026

(54) VEHICLE AIR CONDITIONER

(71) Applicants: HYUNDAI MOTOR COMPANY, Seoul (KR); KIA CORPORATION, Seoul (KR); DOOWON CLIMATE CONTROL CO.,LTD, Asan-si (KR)

(72) Inventors: Myung Jun Kim, Hwaseong-si (KR); Dong Won Yeon, Hwaseong-si (KR); Dong Hyeop Kim, Hwaseong-si (KR); Byung Guk An, Asan-si (KR); Won Jun Joung, Pyeongtaek-si (KR); Nam Jin Baek, Asan-si (KR)

(73) Assignees: HYUNDAI MOTOR COMPANY, Seoul (KR); KIA CORPORATION, Seoul (KR); DOOWON CLIMATE CONTROL CO.,LTD, Asan-si (KR)

(21) Appl. No.: 19/249,638

(22) Filed: Jun. 25, 2025

(30) Foreign Application Priority Data
Nov. 5, 2024 (KR) 10-2024-0154825

(51) Int. Cl. B60H 1/00

(52) U.S. Cl. CPC B60H 1/00671

(57) ABSTRACT

A vehicle air conditioner includes: an air-conditioning case; a PTC heater located inside the air-conditioning case; a partition wall partitioning an area of a rear end of the PTC heater; a first door unit located on one side of the partition wall; a second door unit adjacent to the first door unit, the second door unit being located on the other side of the partition wall; and a controller. The PTC heater includes a first heater zone, a second heater zone, a third heater zone, and a fourth heater zone. The controller is configured to control an opening degree of each of the first door unit and the second door unit so as to follow a set temperature in each area. The controller is also configured to independently drive each of the first to fourth heater zones in response to the opening degree.

### CROSS-REFERENCE TO RELATED APPLICATION

This application claims, under 35 U.S.C. § 119(a), the benefit of and priority to Korean Patent Application No. 10-2024-0154825, filed on Nov. 5, 2024, the entire contents of which are incorporated herein by reference.

### BACKGROUND

### (a) Technical Field

The present disclosure relates to an interior air-conditioning system in a vehicle, and more particularly, to a vehicle air conditioner configured to provide an independent temperature control function and to optimize output characteristics of a positive temperature coefficient (PTC) heater.

### (b) Background Art

A vehicle air-conditioning system is a main element capable of providing a comfortable environment for an occupant by controlling the temperature and air flow in the vehicle interior. The vehicle air-conditioning system of the present disclosure provides a four-zone control function of controlling four zones including the driver's seat, the passenger seat, and the rear seats in the second row through improvement of the existing vehicle air-conditioning system. Further, the vehicle air-conditioning system may variably control an output amount of a PTC heater and an output area thereof so as to provide a temperature appropriately adjusted to each area.

Conventional vehicle air-conditioning systems use horizontal and vertical partition walls fixed at the rear side of a PTC heater so as to divide an air flow and provide appropriate heating to each area. This conventional method enables relatively simple and stable temperature control, and the temperature of each seating area may be independently adjusted through this method.

However, the conventional fixed partition wall method has a problem in that heat pickup occurs in an unused zone among four partitioned zones. When a specific zone is in the OFF state, heat transferred from another zone is unintentionally introduced into the OFF zone, leading to unnecessary heat accumulation. As a result, efficiency of the air-conditioning system deteriorates, and a temperature imbalance between adjacent zones occurs. Accordingly, it is difficult to optimally control the temperature of the vehicle interior.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

In order to address the above-described problems, the vehicle air-conditioning system of the present disclosure variably adjusts a partition wall provided at the rear side of a positive temperature coefficient (PTC) heater so as to independently control heating for each zone. An output amount of the heater and an output area thereof are automatically adjusted depending on the needs of each zone. Through this structural configuration, temperature balance of the vehicle interior may be optimally controlled. Further, unnecessary heat loss may be reduced. Thus, the disclosed vehicle air conditioning system efficiently provides heating required for each zone.

The present disclosure is provided in an effort to solve the above-described problems associated with the prior art. It is an object of the present disclosure to provide an air-conditioning system configured to partition an air-conditioning compartment into left and right air-conditioning compartments using a vertical partition wall. It is another object of the present disclosure to variably adjust upper and lower air-conditioning compartments through a temperature door. Thus, an output area of a heater and an output amount thereof are efficiently controlled depending on the opening degree of the temperature door.

The objects of the present disclosure are not limited to the above-mentioned objects. Other technical objects not mentioned herein should be more clearly understood by those of ordinary skill in the art to which the present disclosure pertains from the detailed description of the embodiments. Additionally, the objects of the present disclosure may be achieved by aspects and combinations thereof as indicated in the claims.

In one aspect, the present disclosure provides a vehicle air conditioning system including: an air-conditioning case; a PTC heater located inside the air-conditioning case; a partition wall partitioning an area of a rear end of the PTC heater; a first door unit located on one side of the partition wall; and a second door unit adjacent to the first door unit. The second door unit is located on the other side of the partition wall. The PTC heater includes a first heater zone located in an area facing an upper end of the first door unit and a second heater zone located in an area facing a lower end of the first door unit. The PTC heater also includes a third heater zone located in an area facing an upper end of the second door unit and a fourth heater zone located in an area facing a lower end of the second door unit. The vehicle air conditioning system further includes a controller configured to control an opening degree of each of the first door unit and the second door unit so as to follow a set temperature in each area. The controller is also configured to independently drive each of the first to fourth heater zones in response to the opening degree.

In an embodiment, the first door unit may include a first temperature door located adjacent to an upper end of the one side of the partition wall and may include a first sub-door located below the first temperature door. The first sub-door may be located adjacent to a lower end of the one side of the partition wall.

In another embodiment, the second door unit may include a second temperature door located adjacent to an upper end of the other side of the partition wall and may include a second sub-door located below the second temperature door. The second sub-door may be located adjacent to a lower end of the other side of the partition wall.

In still another embodiment, the air-conditioning case may include a first flow path located facing the first heater zone. The first flow path may be fluidly connected to one end of a front seat. The air conditioning case may also include a second flow path located facing the second heater zone. The second flow path may be fluidly connected to one end of a rear seat. The air conditioning case may further include a third flow path located facing the third heater zone. The third flow path may be fluidly connected to the other end of the front seat. The air conditioning case may also include a fourth flow path located facing the fourth heater zone. The fourth flow path may be fluidly connected to the other end of the rear seat.

In yet another embodiment, the first flow path may be fluidly connected to the first heater zone when the controller opens the first temperature door. The first flow path may be blocked when the controller closes the first temperature door. The second flow path may be fluidly connected to the second heater zone when the controller opens the first sub-door. The second flow path may be blocked when the controller closes the first sub-door.

In still yet another embodiment, the third flow path may be fluidly connected to the third heater zone when the controller opens the second temperature door. The third flow path may be blocked when the controller closes the second temperature door. The fourth flow path may be fluidly connected to the fourth heater zone when the controller opens the second sub-door. The fourth flow path may be blocked when the controller closes the second sub-door.

In a further embodiment, the controller may be configured to determine or calculate, based on a difference between an actual temperature and the set temperature, a required heat load corresponding to each zone. The controller may be configured to vary, in response to the required heat load, a size of at least one of the areas of the first to fourth heater zones.

In another further embodiment, the controller, in response to the different or respective required heat loads in the respective first to fourth heater zones, may be configured to independently drive the first to fourth heater zones so as to generate different outputs in the respective first to fourth heater zones.

In still another further embodiment, the controller may be configured to move the first temperature door so as to close the first flow path when an interior temperature exceeds the set temperature at the one end of the front seat. The controller may be configured to move the first temperature door so as to open the first flow path when the interior temperature is equal to or lower than the set temperature at the one end of the front seat.

In yet another further embodiment, the controller may be configured to move the first sub-door so as to open the second flow path when the interior temperature is lower than the set temperature at the one end of the rear seat. The controller may be configured to move the first sub-door so as to close the second flow path when the interior temperature exceeds the set temperature at the one end of the rear seat.

In still yet another further embodiment, the controller may be configured to vary the areas of the first heater zone and the second heater zone in response to the respective required heat loads at the one end of the front seat and the one end of the rear seat. The controller may be configured to control the respective outputs of the first heater zone and the second heater zone in response to the different required heat loads.

In a still further embodiment, the controller may be configured to move the second temperature door so as to close the third flow path when an interior temperature exceeds the set temperature at the other end of the front seat. The controller may be configured to move the second temperature door so as to open the third flow path when the interior temperature is equal to or lower than the set temperature at the other end of the front seat.

In a yet still further embodiment, the controller may be configured to move the second sub-door so as to open the fourth flow path when the interior temperature is lower than the set temperature at the other end of the rear seat. The controller may be configured to move the second sub-door so as to close the fourth flow path when the interior temperature exceeds the set temperature at the other end of the rear seat.

In another embodiment, the controller may be configured to vary the areas of the third heater zone and the fourth heater zone in response to the respective required heat loads at the other end of the front seat and the other end of the rear seat. The controller may be configured to control the respective outputs of the third heater zone and the fourth heater zone in response to the different required heat loads.

In still another embodiment, the controller, when air is discharged only to the one end of the front seat, may be configured to move the first temperature door so as to open the first flow path and to move the first sub-door so as to close the second flow path.

In yet another embodiment, the controller, when the interior temperature is lower than the set temperature at the one end of the front seat, may be configured to vary the size of each of the areas of the first heater zone and the second heater zone in response to the required heat load at the one end of the front seat. The controller maybe configured to control the output of the first heater zone and to cut off power of the second heater zone.

Other aspects and embodiments of the disclosure are discussed herein.

It should be understood that the terms “vehicle”, “vehicular”, and other similar terms as used herein are inclusive of motor vehicles in general. Such motor vehicles may encompass passenger automobiles including sport utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed herein.

### BRIEF DESCRIPTION OF THE DRAWINGS

The above and other features of the present disclosure are described in detail with reference to certain example embodiments thereof illustrated in the accompanying drawings, which are given hereinbelow by way of illustration only, and thus are not limitative of the present disclosure, and wherein:

FIG. 1 is a side view of a vehicle air conditioner, according to an embodiment of the present disclosure;

FIG. 2 is an enlarged view of a rear end of a vehicle air conditioner including a positive temperature coefficient (PTC) heater, according to the embodiment of the present disclosure;

FIG. 3A is a view showing an operation mechanism in which air at a rear end of a PTC is discharged to a rear seat, according to the embodiment of the present disclosure;

FIG. 3B is a view showing the output of the PTC heater of FIG. 3A when the air at the rear end of the PTC heater is discharged to the rear seat, according to the embodiment of the present disclosure;

FIG. 4A is a view showing an operation mechanism in which the air at a rear end of a PTC heater is discharged to a front seat and a rear seat, according to the embodiment of the present disclosure;

FIG. 4B is a view showing the output of the PTC heater of FIG. 4A when the air at the rear end of the PTC heater is discharged to the front seat and the rear seat, according to the embodiment of the present disclosure;

FIG. 5A is a view showing an operation mechanism in which the air at a rear end of a PTC heater is discharged to a front seat, according to the embodiment of the present disclosure;

FIG. 5B is a view showing the output of the PTC heater of FIG. 5A when the air at the rear end of the PTC heater is discharged to the front seat, according to the embodiment of the present disclosure;

FIG. 6A is a view showing an operation mechanism in which the air of a PTC heater is discharged to a first flow path when the air is discharged only to one end of a front seat, according to the embodiment of the present disclosure;

FIG. 6B is a view showing the output of the PTC heater of FIG. 6A when the air is discharged only to one end of the front seat and the air at the rear end of the PTC heater is discharged to the first flow path;

FIG. 7A is a view showing an operation mechanism of a PTC heater when a first flow path is partially opened in a drive-only mode, according to the embodiment of the present disclosure; and

FIG. 7B is a view showing the output of the PTC heater of FIG. 7A when the first flow path is partially opened in the drive-only mode, according to the embodiment of the present disclosure.

It should be understood that the appended drawings are not necessarily shown to scale, presenting a somewhat simplified representation of various features illustrative of the basic principles of the disclosure. The specific design features of the present disclosure as presented herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below. While technical concepts of the disclosure are described in conjunction with certain example embodiments, it should be understood that the present description is not intended to limit the disclosure to the example embodiments. On the contrary, the disclosure is intended to cover not only the example embodiments, but also various alternatives, modifications, equivalents, and other embodiments, which may be included within the spirit and scope of the disclosure as defined by the appended claims. The present embodiments are provided to more fully explain the technical concepts of the disclosure to those of ordinary knowledge in the art.

Terms such as “part”, “unit”, and “module” described in the specification mean a unit configured to process at least two functions or operations. Such a unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

When a portion “comprises” or “includes” a certain component throughout the specification, this means that the portion may further comprise or include other components without excluding the other components unless stated otherwise. When a component, device, unit, module, controller, element, or the like of the present disclosure is described as having a purpose or performing an operation, function, or the like, the component, device, unit, module, controller, or element should be considered herein as being “configured to” meet that purpose or to perform that operation or function. The present disclosure describes a controller an air conditioner. The controller or other such components may separately embody or be included with a processor and a memory, such as a non-transitory computer readable media, as part of the controller or component.

According to the disclosure, a controller 300 may be implemented by an algorithm configured to control the operation of various components disposed in the vehicle, a memory configured to store data about a program that reproduces the algorithm, and a processor configured to perform the above-described operation using data stored in the memory. In this case, the memory and the processor may be implemented as separate chips. Alternatively, the memory and the processor may be implemented as a single chip. The controller 300 may include at least two of an electronic control unit (ECU), a central processing unit (CPU), a microprocessor unit (MPU), a microcontroller unit (MCU), an application processor (AP), or any type of processor well known in the technical field of the present disclosure.

Furthermore, the controller 300 may be formed of a combination of software and hardware capable of performing a determination, such as by calculation on at least two applications or programs for executing a method according to embodiments of the present disclosure.

In addition, in the following specification, one side means the driver's seat side of the vehicle and the other side means the passenger seat side of the vehicle. Thus, for example, when referring to one side of a front seat, the front seat on the driver's side is referenced. Similarly, when referring to the other side of a rear seat, the passenger side rear seat is referenced.

More specifically, in the following specification, an area of a vehicle air conditioner is partitioned into four zones. The four zones may be one end of the front seat, the other end of the front seat, one end of the rear seat, and the other end of the rear seat, respectively. In one example, the one end of the front seat means the driver's seat in the first row, the other side of the front seat means the passenger seat in the first row, the one end of the rear seat means the rear seat in the second row, which is located at the rear side of the driver's seat, and the other end of the rear seat means the rear seat in the second row, which is located at the rear side of the passenger seat. Therefore, the area may be partitioned into the driver's seat in the first row, the passenger seat in the first row, the rear seat in the second row, which is located at the rear side of the driver's seat, and the rear seat in the second row, which is located at the rear side of the passenger seat.

In addition, in the following specification, the interior temperature means an interior temperature measured by a temperature sensor disposed in an individual area. In one example, the interior temperature of the driver's seat in the first row may be measured by a sensor located at an outlet of a first flow path 140. The interior temperature of the passenger seat in the first row may be measured by a sensor located at an outlet of a third flow path 160. The interior temperature of the rear seat in the second row, which is located at rear side of the driver's seat, may be measured by a sensor located at an outlet of a second flow path 150. The interior temperature of the rear seat in the second row, which is located at the rear side of the passenger seat, may be measured by a sensor located at an outlet of a fourth flow path 170.

Further, in the following specification, the set temperature means a set temperature for each individual area, which is stored in the controller 300.

Hereinafter, embodiments are described in detail with reference to the accompanying drawings. In describing the embodiments with reference to the accompanying drawings, the same or corresponding components are denoted by the same reference numerals and redundant descriptions thereof have been omitted.

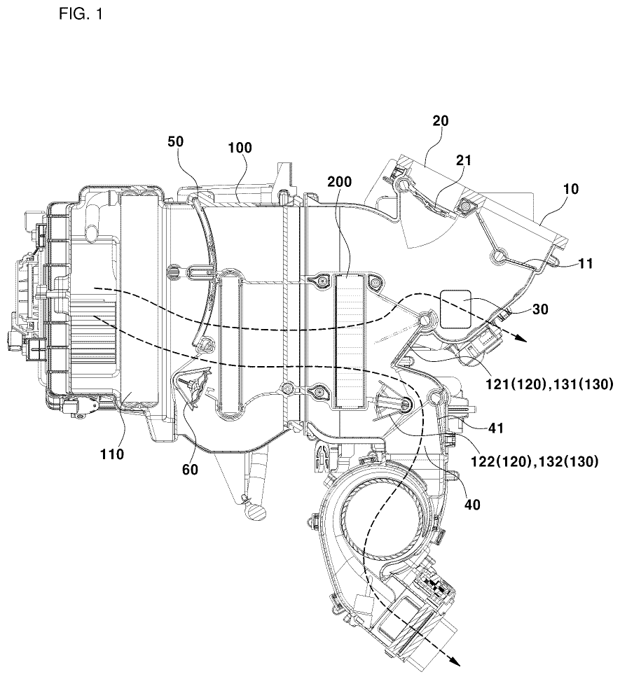

FIG. 1 is a side view of a vehicle air conditioner according to an embodiment of the present disclosure.

According to the embodiment of the present disclosure, a vehicle air conditioner includes an air-conditioning case 100, a positive temperature coefficient (PTC) heater 200, a partition wall 190 mounted at the rear end of the PTC heater 200, a first door unit 120 located adjacent to one side of the partition wall 190, and a second door unit 130 located adjacent to the other side of the partition wall 190. The air conditioner also includes at least one controller 300, which may be a part of the device, such as within the case 100, or which may be at least partly remote from the device.

Furthermore, the controller 300 may be configured to receive an interior temperature from a vehicle interior temperature sensor and to control an opening degree of the first door unit 120 and the second door unit 130 so as to follow a set temperature of the first and second rows of the vehicle. Furthermore, the controller 300 independently controls the operation of a first heater zone 210, a second heater zone 220, a third heater zone 230, and the fourth heater zone 240 according to the opening degree.

The PTC heater 200 of the vehicle air conditioner includes, based on the first door unit 120 and the second door unit 130, the first heater zone 210 and the second heater zone 220 partitioned by the first door unit 120 and includes the third heater zone 230 and the fourth heater zone 240 partitioned by the second door unit 130.

The air-conditioning case 100 has a first flow path 140 and a second flow path 150 each formed therein. The first flow path 140 faces the first heater zone 210 and is fluidly connected to one end of the front seat. The second flow path 150 faces the second heater zone 220 and is fluidly connected to one end of the rear seat. In addition, the air-conditioning case 100 has a third flow path 160 and a fourth flow path 170 each formed therein. The third flow path 160 faces the third heater zone 230 and is fluidly connected to the other end of the front seat. The fourth flow path 170 faces the fourth heater zone 240 and is fluidly connected to the other end of the rear seat.

The upper end of the air-conditioning case 100 is connected to a face vent 10, which directs air toward the upper side of the front seat. Further, the air-conditioning case 100 has an inner side adjacent to the face vent 10. The inner side is fluidly connected to the first flow path 140 and the third flow path 160. In addition, the first flow path 140 and the third flow path 160 are partitioned into left and right spaces in the width direction of the vehicle with the partition wall 190 of the air-conditioning case 100 interposed therebetween. Furthermore, the first flow path 140 is fluidly connected to the front driver's seat of the air-conditioning case and the third flow path 160 is fluidly connected to the front passenger's seat. Therefore, the air inside the air-conditioning case is discharged to the driver's seat in the first row through the first flow path 140 and to the passenger's seat in the first row through the third flow path 160.

The air-conditioning case 100 has a lower end fluidly connected to the rear seat vent 40 whereby air flows to the rear seat. Further, the air-conditioning case 100 has a lower inner side adjacent to the rear seat vent 40. The lower inner side is fluidly connected to the second flow path 150 and the fourth flow path 170. The second flow path 150 and the fourth flow path 170 are partitioned by the partition wall 190 inside the air-conditioning case 100. The second flow path 150 is fluidly connected to one end of the rear seat, i.e., the rear end of the driver's seat, and the fourth flow path 170 is fluidly connected to the other end of the rear seat, i.e., the rear end of the passenger's seat. Therefore, the air inside the air-conditioning case 100 is discharged to one end of the rear seat through the second flow path 150 and to the other end of the rear seat through the fourth flow path 170.

When a front door 50 located between an evaporator 110 and the PTC heater 200 is opened, air flowing into the air-conditioning case 100 and passing through the evaporator 110 flows into the PTC heater 200 and exchanges heat with the first heater zone 210 and the third heater zone 230. Then, the air may be discharged to the driver's seat in the first row through the first flow path 140 or may be discharged to the passenger seat in the first row through the third flow path 160.

Furthermore, when a rear door 60, located at the lower end of the front door 50 and disposed between the evaporator 110 and the PTC heater 200, is opened, the low-temperature air that has passed through the evaporator 110 may exchange heat with the second heater zone 220 and the fourth heater zone 240. Then, the air may be discharged to the rear seat in the second row, which is located at the rear side of the driver's seat, through the second flow path 150 or may be discharged to the rear seat in the second row, which is located at the rear side of the passenger seat, through the fourth flow path 170.

Furthermore, at the upper end of the inside of the air-conditioning case 100, the low-temperature air that has passed through the evaporator 110 and has not passed through the PTC heater 200 and the high-temperature air that has passed through the first heater zone 210 or the third heater zone 230 may be mixed and discharged to the front seat. In addition, at the lower end of the inside of the air-conditioning case 100, the low-temperature air and the air that passed through the second heater zone 220 or the fourth heater zone 240 may be mixed and discharged to the rear seat.

The first door unit 120 is located at the rear end of the PTC heater 200 and is located on one side of the partition wall 190. The first door unit 120 is located adjacent to a front seat foot vent 30 and is formed of a first temperature door 121 that controls the temperature of air flowing to the front seat and a first sub-door 122 located below the first temperature door 121 and adjacent to a rear vent door 41.

The first temperature door 121 is configured to define one area of the PTC heater 200 in response to a required heat load calculated by causing the controller 300 to compare an interior temperature at each of one end of the front seat and one end of the rear seat with a set temperature stored in a controller of each zone. In one example, the interior temperature means an interior temperature at each of one end of the front seat and one end of the rear seat.

The PTC heater 200 may be partitioned by the first temperature door 121 into the first heater zone 210 located in a first area facing the upper end of the first temperature door 121 and a second heater zone 220 located in a second area facing the lower end of the first temperature door 121. In one example, the size of the first heater zone 210 and the size of the second heater zone 220 may vary in response to the required heat load.

The second door unit 130 is located adjacent to the other side of the PTC heater 200 with respect to the partition wall 190 and is formed of a second temperature door 131 and a second sub-door 132. The second temperature door 131 partitions the other side area of the PTC heater 200 into upper and lower areas in response to the required heat load. In one example, the second temperature door 131 is configured to partition the other side area of the PTC heater 200 into the third heater zone located in a third area facing the upper end of the second temperature door 131 and the fourth heater zone located in a fourth area facing the lower end of the second temperature door 131. The size of the third heater zone and the size of the fourth heater zone may vary in response to the required heat load, similarly to the first heater zone 210 and the second heater zone.

In addition, the first flow path 140 is fluidly connected to the first heater zone when the first temperature door 121 is opened. Furthermore, the first flow path 140 is blocked when the first temperature door 121 is closed. The second flow path 150 is fluidly connected to the second heater zone when the first sub-door 122 is opened. Further, the second flow path 150 is blocked when the first sub-door 122 is closed, thereby restricting the flow of air.

Therefore, when the first temperature door 121 is opened and the first sub-door 122 is opened, air may flow to the first flow path 140 and the second flow path 150. Furthermore, when only the first sub-door 122 is opened, air flows to the second flow path 150, and when only the first temperature door 121 is opened, air flows to the first flow path 140.

The third flow path 160 is fluidly connected to the third heater zone when the second temperature door 131 is opened. Further, the third flow path 160 is blocked when the second temperature door 131 is closed. When the second sub-door 132 is opened, the fourth flow path 170 allows air from the fourth heater zone to flow thereinto, and when the second sub-door 132 is closed, the air from the fourth heater zone is blocked from flowing into the fourth flow path.

Through this configuration, when the second temperature door 131 and the second sub-door 132 are simultaneously opened, air may flow into the third flow path 160 and the fourth flow path 170, and when only one of the second temperature door 131 and the second sub-door 132 is opened, air may flow through the flow path fluidly connected to the opened door.

The controller 300 of the present disclosure controls an opening degree of the first door unit 120 and the second door unit 130 in order to follow a set temperature for each zone, the set temperature being stored in the controller 300. Furthermore, the controller 300 independently drives each of the first heater zone 210, the second heater zone 220, the third heater zone 230, and the fourth heater zone 240 in response to the opening degree of the first door unit 120 and the second door unit 130. Here, driving includes not only a signal for applying power to the PTC heater 200, but also a voltage, a pulse width modulation signal, a current, a temperature setting signal, and/or the like applied to generate heat corresponding to the required heat load.

In addition, the controller 300 compares the interior temperature on the one end side of the front seat with a set temperature on the one end side of the front seat. The set temperature is stored in the controller 300. When the interior temperature exceeds the set temperature, the controller 300 moves the first temperature door 121 to block the first flow path 140. Furthermore, the controller 300 moves the first temperature door 121 to open the first flow path 140 when the interior temperature is equal to or lower than the set temperature.

In addition, the controller 300 compares the interior temperature on the one end side of the rear seat with a set temperature on the one end side of the rear seat. The set temperature is stored in the controller 300. When the interior temperature is lower than the set temperature, the controller 300 moves the first sub-door 122 to open the second flow path 150, and when the interior temperature exceeds the set temperature, the controller 300 moves the first sub-door 122 to block the second flow path 150.

Furthermore, the controller 300 compares the interior temperature on the other end side of the front seat with a set temperature on the other end side of the front seat. The set temperature is again stored in the controller 300. When the interior temperature exceeds the set temperature, the controller 300 rotates the second temperature door 131 to block the third flow path 160. When the interior temperature is equal to or lower than the set temperature, the controller 300 moves the second temperature door 131 to open the third flow path 160.

Further, the controller 300 compares the interior temperature on the other end side of the rear seat with a set temperature on the other end side of the rear seat. The set temperature is yet again stored in the controller 300. When the interior temperature is lower than the set temperature, the controller 300 moves the second sub-door 132 to open the fourth flow path 170. When the interior temperature exceeds the set temperature, the controller rotates the second sub-door 132 to block the fourth flow path 170.

In addition, the controller 300 compares the interior temperature in each zone with the set temperature in each zone, which is stored in the controller 300, so as to calculate or determine a required heat load for each zone. For example, when the set temperature stored for one of the individual zones is 24 degrees and the current interior temperature in the individual zone is 20 degrees, a temperature difference is 4 degrees. In this case, the controller 300 determines or calculates the required heat, i.e., required heat load, with reference to the temperature difference. As the temperature difference increases, the required heat load becomes larger. Through the determined or calculated result, the controller 300 may determine that more heat is required. On the other hand, when the temperature difference is small, the controller 300 may determine that relatively less heat is required.

In addition, the controller 300 may vary the size of at least one of the first heater zone 210, the second heater zone 220, the third heater zone 230, and/or the fourth heater zone 240 based on the calculated required heat load. For example, when the controller 300 determines that the required heat load calculated on the one end side of the rear seat is greater than the required heat load calculated on the one end side of the front seat, one side of the PTC heater 200 may be partitioned such that the size of the area of the second heater zone 220 is larger than the size of the area of the first heater zone 210. As another example, when the controller 300 determines that the required heat load calculated on the other end side of the rear seat and the one end side of the front seat are the same, one side of the PTC heater 200 may be partitioned such that the size of the area of the first heater zone 210 and the size of the area of the second heater zone 220 are the same. Furthermore, the controller 300 may partition the third heater zone 230 and the fourth heater zone 240 in response to the required heat load. In one example, when the required heat loads in the four zones are all different from each other, the sizes of each of the first heater zone 210 to the fourth heater zone 240 may be adjusted such that the respective zones have different areas.

In addition, the controller 300 may control the opening degree of the first temperature door 121 and the opening degree of the second temperature door 131 in response to the required heat load. For example, assuming that 40% of the output is required to follow the set temperature on the one end side of the front seat, and 60% of the output is required to follow the set temperature on the one end side of the rear seat, the ratio of the size of the first heater zone 210 to the size of the second heater zone 220 may be adjusted to 4:6 by the controller. In this case, when the width direction length of the PTC heater 200 is constant, the controller 300 may control the opening degree of the first temperature door 121. Thus, the first temperature door 121 is located at a point where the ratio of the height of the first heater zone 210 to the height of the second heater zone 220 is adjusted to 4:6 in the vehicle height direction.

In addition, the controller 300 performs a drive-only control mode in which air is discharged only to the driver's seat in the first row when a user request is input or driving power of a vehicle is below a certain range. Furthermore, the drive-only control mode may be performed when a user manually selects a drive-only button or may be performed in an auto mode in which the drive-only control mode is automatically performed according to a predetermined condition. In one example, the drive-only control mode may be performed when a difference between the vehicle's interior temperature and the outdoor temperature is within a predetermined range in the auto mode, when the vehicle's interior temperature reaches the set interior temperature stored in the controller, and when the energy saving mode is in effect.

In addition, in the drive-only control mode, the controller 300 operates only the first heater zone 210 in response to the required heat load and cuts off power to the second heater zone 220 so as to keep the second heater zone 220 in the OFF state.

Additionally, in another embodiment of the present disclosure, the first to fourth areas of the first heater zone 210 to the fourth heater zone 240 may be partitioned in inverse proportion to the required heat load. For example, when the required heat load calculated at one end of the front seat is greater than the required heat load calculated at one end of the rear seat, the size of the area of the first heater zone 210 may be smaller than the size of the area of the second heater zone 220.

In addition, when the required heat loads calculated in the four zones are different, the controller 300 may apply a signal to generate different outputs in each of the first heater zone 210 to the fourth heater zone 240 depending on the required heat load in each zone.

Furthermore, the controller 300 may adjust the output amount by adjusting voltage applied to each heater zone. Specifically, when the required heat load in the first heater zone 210 is greater than the required heat loads in each of the second heater zone 220 to the fourth heater zone 240, the controller 300 increases voltage applied to the first heater zone 210 so as to supply more power thereto.

Additionally, the controller 300 may adjust current intensity in response to the required heat load in each heater zone. Since the current intensity directly affects the amount of heat generation, the controller 300 may finely adjust heat generated in each zone by adjusting current in response to the required heat load in each heater zone.

In addition, the controller 300 may more finely adjust the power applied to each heater zone by using a pulse width modulation (PWM) method. The pulse width modulation method is a method of controlling average power by adjusting an ON-time and an OFF-time while constantly maintaining a signal cycle. For example, when an average output of 60% is required in the third heater zone 230, the controller 300 may adjust an output amount suitable for the required heat load in the third heater zone 230 through the control of a PWM signal by setting a time during which current flows to 60%.

Therefore, the controller 300 may precisely control the output amount of each heater zone through the voltage, current, and PWM signal, thereby reliably maintaining a comfortable temperature inside the vehicle.

In addition, the controller 300 controls the first temperature door 121, the second temperature door 131, the first sub-door 122, and the second sub-door 132 so as to open and close the first flow path 140, the second flow path 150, the third flow path 160, and the fourth flow path 170 in response to the required heat load.

For example, when the interior temperature on the one end side of the rear seat and the interior temperature on the other end side of the rear seat are respectively lower than the respective set temperature on the one end side of the rear seat and the set temperature on the other end side of the rear seat, the first temperature door 121 is closed to block the first flow path 140, and the second temperature door 131 is closed to block the third flow path 160. Furthermore, the controller 300 opens the first sub-door 122 to open the second flow path 150, and opens the second sub-door 132 to open the fourth flow path 170. At this time, the first temperature door 121 is rotated to be adjacent to the uppermost end of the PTC heater 200 such that only the second heater zone 220 is formed on one side of the PTC heater 200. Furthermore, only the fourth heater zone 240 is formed on the other side of the PTC heater 200 through rotation of the second temperature door 131. In addition, when the required heat load is the same on the one end side of the rear seat and the other end side thereof, the controller 300 applies a signal so as to generate the same output in the second heater zone 220 and the fourth heater zone 240.

In other words, the controller 300 compares the interior temperature in each zone with the respective set temperature in each zone stored in the controller 300, and determines or calculates the required heat load in each zone. In addition, the controller 300 may variably adjust the respective first to fourth areas of each of the first heater zone 210 to the fourth heater zone 240 in response to the required heat loads calculated for the respective zones. The controller 300 may also perform a control operation to apply signals to generate different output amounts in the first heater zone 210 to the fourth heater zone 240.

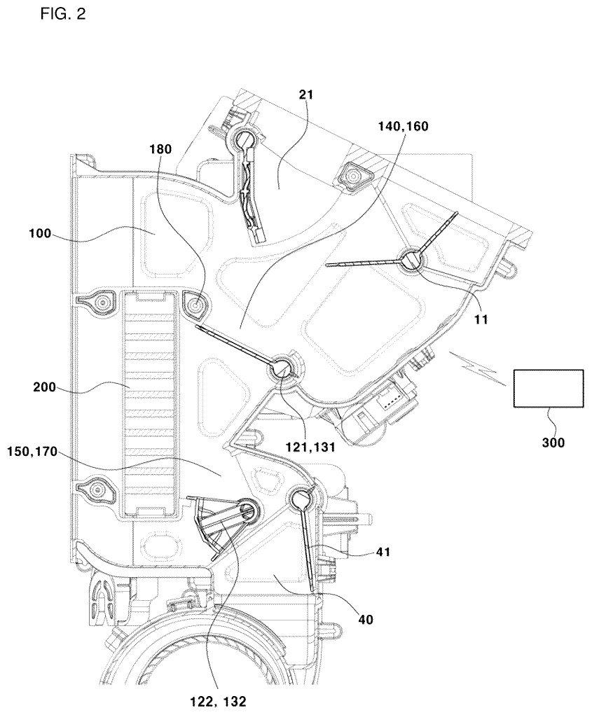

FIG. 2 is an enlarged view of the rear end of the air conditioner and the PTC heater 200.

According to the embodiment of the present disclosure, the first temperature door 121 and the second temperature door 131 may be disposed at a location higher than a central portion of the PTC heater 200 in the vehicle height direction. Furthermore, the location of the first temperature door 121 may be adjusted in consideration of a distribution of the air flow or the amount of air discharged to the front and rear seats.

In addition, the first temperature door 121 is rotated around a shaft penetrating both sides of the rear end of the air-conditioning case 100, the shaft being adjacent to the front foot vent 30. In one example, the first temperature door 121 may be designed to be rotated around the shaft relative to a rib 180 located at the upper side of the rear end of the PTC heater 200 and may be rotatable 120 degrees in a direction toward the lower end of the air-conditioning case 100.

Additionally, when the first temperature door 121 is rotated in a direction toward the rib 180, the first flow path 140 is closed. Furthermore, when the first temperature door 121 is rotated in a direction away from the rib 180, i.e., in a direction toward the lower end of the air-conditioning case 100, the first flow path 140 is opened.

Further, when the first temperature door 121 is rotated in a direction toward the rib 180 and comes into contact with the rib 180, the first flow path 140 is completely sealed. Furthermore, when the first temperature door 121 is rotated in a direction away from the rib 180 by the maximum rotation angle, the first flow path 140 is completely opened.

In addition, the first temperature door 121 may be manufactured from a material having high heat resistance and durability because the air passing through the PTC heater 200 may rise to a maximum of 100 degrees or higher. In one example, heat-resistant nylon containing a glass fiber additive may be used for the first temperature door. In addition, the first temperature door 121 may be manufactured in a flap shape.

The second temperature door 131 also has the same features as those of the first temperature door 121. When the second temperature door 131 is rotated in a direction toward the rib 180, the second flow path 150 is closed. Furthermore, when the second temperature door 131 is rotated in a direction toward the lower end of the air-conditioning case 100, the second flow path 150 is opened.

In addition, the first sub-door 122 is located at the lower end of the air-conditioning case 100 and opens and closes the second flow path 150 in conjunction with the rear vent door 41 such that the air passing through the rear end of the PTC heater 200 is discharged to the rear seat. Furthermore, the first sub-door 122 is rotated around a shaft penetrating both sides of the lower end of the air-conditioning case 100, the shaft being located adjacent to the rear vent 40.

In a state in which the rear vent door 41 is opened, when the first sub-door 122 is rotated in a direction toward the lower end of the air-conditioning case 100, the second flow path 150 is opened. At this time, the second flow path 150 is fluidly connected to the second heater zone 220. Furthermore, when the first sub-door 122 is rotated in a direction toward the first temperature door 121, the second flow path 150 is closed. However, even if the first sub-door 122 is opened, when the rear vent door 41 is closed, the second flow path 150 may be closed.

Furthermore, the first sub-door 122 is formed to have a fan shape and is opened when it is necessary to increase the temperature of the air discharged to the rear seat. In this case, the low-temperature air that has passed through the evaporator 110 and the rear door 60 and the high-temperature air that has passed through the PTC heater 200 may be mixed and discharged to the rear seat.

The second sub-door 132 also has the same features as those of the first sub-door 122. When the second sub-door 132 is rotated in a direction toward the lower end of the air-conditioning case 100, the fourth flow path 170 is opened. At this time, the fourth flow path 170 is fluidly connected to the fourth heater zone 240. Furthermore, when the second sub-door 132 is rotated in a direction toward the second temperature door 131, the fourth flow path 170 is closed such that air may not be discharged to the rear seat through the fourth flow path 170.

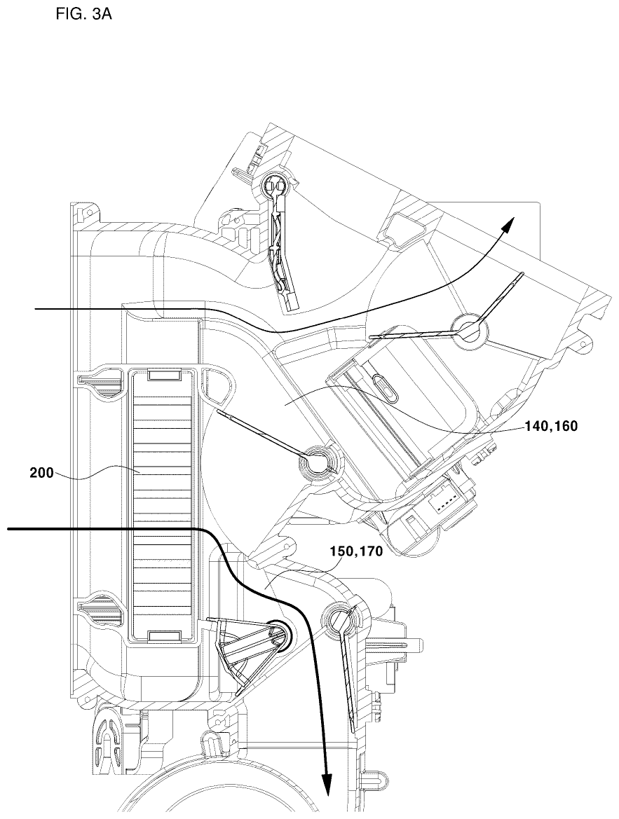

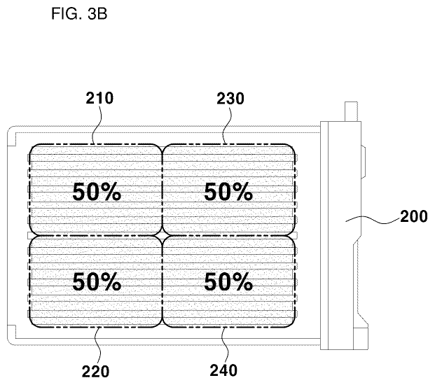

FIG. 3A is a view showing an operating mechanism in which air at the rear end of the PTC heater 200 is discharged to one end and the other end of the rear seat. FIG. 3B is a view showing the output of the PTC heater 200 in this case.

In the embodiment of the present disclosure, when the interior temperature at one end of the front seat exceeds the set temperature at one end of the front seat, which is stored in the controller 300, and the interior temperature at one end of the rear seat is lower than the set temperature at one end of the rear seat, which is stored in the controller 300, the controller 300 moves the first temperature door 121 to close the first flow path 140 and moves the first sub-door 122 to open the second flow path 150. Furthermore, the controller 300 opens the rear vent door 41 to cause all of the air passing through the PTC heater 200 to flow to the rear seat vent 40.

In this case, the first temperature door 121 is moved adjacent to the uppermost end of the PTC heater 200, and the area of the second heater zone 220 gradually increases. When the first temperature door 121 comes into contact with the rib 180, the first flow path 140 is closed.

Furthermore, the controller 300 may control the first temperature door 121 in a direction of increasing the area of the second heater zone 220 in response to the required heat load. In other words, the controller 300 may vary the size of the second area of the second heater zone 220 in response to the required heat load.

In this case, the controller 300 may apply a signal to generate an output corresponding to the required heat load at one end of the rear seat in the second heater zone 220.

For example, when the interior temperature is 22 degrees and the set temperature at one end of the rear seat is 24 degrees, the second heater zone 220 may receive a signal from the controller 300 so as to generate 40% of the output. Further, when the interior temperature is 22 degrees and the set temperature at one end of the rear seat is 26 degrees, more heat load is required than when the set temperature at one end of the rear seat is 24 degrees. In this case, the second heater zone 220 may receive a signal from the controller 300 so as to generate 50% of the output. In other words, the controller 300 may adjustably control the output of the second heater zone 220 in response to the required heat load at one end of the rear seat. However, the output of the heater zone may vary depending on the required heat load, but the present disclosure is not limited to an embodiment of the following specification.

Therefore, the air passing through the rear end of the PTC heater 200 may be discharged to the front end of the rear seat. The low-temperature air flowing along the outer edge of the PTC may be discharged to the front seat depending on whether each vent is opened or closed.

According to another embodiment of the present disclosure, when the interior temperature at the other end of the front seat exceeds the set temperature at the other end of the front seat, which is stored in the controller 300, and the interior temperature at the other end of the rear seat is lower than the set temperature at the other end of the rear seat, which is stored in the controller 300, the controller 300 rotates the second temperature door 131 in a direction of blocking the third flow path 160, and moves the second sub-door 132 such that the fourth flow path 170 is fluidly connected to the fourth heater zone 240.

In this case, the second temperature door 131 is moved in a direction toward the rib 180, and the area of the fourth heater zone 240 gradually increases. When the second temperature door 131 is located closest to the upper end of the PTC, the third flow path 160 is closed. Furthermore, the controller 300 may gradually increase the fourth area of the fourth heater zone 240 so as to calculate the output according to the required heat load at the other end of the rear seat. In this case, the other side of the PTC heater 200 may be configured as the fourth heater zone 240.

Furthermore, the controller 300 may apply a signal to generate an output corresponding to the required heat load at the other end of the rear seat in the fourth heater zone 240. Therefore, the air passing through the PTC heater 200 may undergo heat exchange in the fourth heater zone 240 to increase the temperature thereof and may be discharged to the other end of the rear seat.

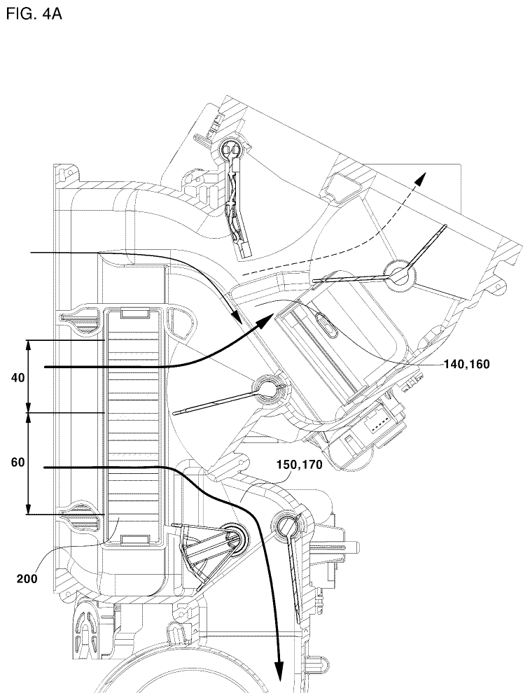

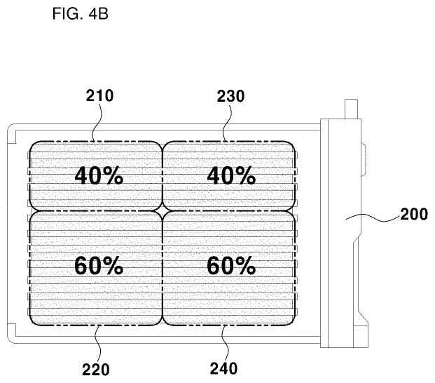

FIG. 4A is a view showing an operation mechanism in which air at the rear end of the PTC heater 200 is discharged to the front seat and the rear seat. FIG. 4B is a view showing the output of the PTC heater 200 when the air at the rear end of the PTC heater 200 is discharged to the front seat and the rear seat.

According to the embodiment of the present disclosure, when the interior temperature at one end of the front seat is lower than the set temperature at one end of the front seat, which is stored in the controller 300, and the interior temperature at one end of the rear seat is lower than the set temperature at one end of the rear seat, which is stored in the controller 300, the controller 300 rotates the first temperature door 121 to open the first flow path 140, and opens the first sub-door 122 to open the second flow path 150.

In addition, the controller 300 calculates the required heat load at one end of the front seat and the required heat load at one end of the rear seat, and compares the required heat loads. Furthermore, the controller 300 adjusts the boundary of one side of the PTC heater 200 based on the required heat load at one end of the front seat and the required heat load at one end of the rear seat. In one example, the controller 300 may differently partition the first area of the first heater zone 210 and the second area of the second heater zone in response to the required heat load at one end of the front seat and the required heat load at one end of the rear seat. Furthermore, the controller 300 may compare the required heat load at one end of the front seat and one end of the rear seat to determine the optimal position of the first temperature door 121 along the boundary between the first heater zone 210 and the second heater zone 220.

For example, when the required heat load at one end of the rear seat is greater than the required heat load at one end of the front seat, the controller 300 may partition one side of the PTC heater 200 such that the second area of the second heater zone 220 is larger than the first area of the first heater zone 210. At this time, the controller 300 may move the first temperature door 121 to the boundary line between the first heater zone 210 and the second heater zone 220. In one example, the first temperature door 121 may be located in response to a ratio of an output in the first heater zone 210 to an output in the second heater zone 220 according to the required heat load at one end of the front seat and the required heat load at one end of the rear seat.

As shown in the drawing, the controller 300 may differently control the output of the first heater zone 210 and the output of the second heater zone 220 in response to the required heat load at one end of the front seat and the required heat load at one end of the rear seat. In one example, when a signal for 40% of the output is applied to the first heater zone 210 according to the required heat load at one end of the front seat and a signal for 60% of the output is applied to the second heater zone 220 according to the required heat load at one end of the rear seat, the first temperature door 121 is located at a position where a ratio of a height of the first heater zone 210 to a height of the second heater zone 220 is 4:6 in the vehicle height direction on one side of the PTC heater 200. Here, the total height including the height of the first heater zone 210 and the height of the second heater zone 220 indicates a vertical distance from the lower end of the PTC heater 200 to the upper end of the PTC heater 200.

That is to say, the controller 300 may vary the respective first and second areas of the first heater zone 210 and the second heater zone 220 according to the required heat load at one end of the front seat and the required heat load at one end of the rear seat. The controller 300 may differently control the output amount of the first heater zone 210 and the output amount of the second heater zone 220 through a positional relationship between the first temperature door 121 and the PTC heater 200.

Through this configuration, the air passing through the first heater zone 210 may be mixed with the air passing through the evaporator 110 at the upper end of the air-conditioning case 100, and then the mixed air may be discharged to the front seat depending on whether a face door 11 is opened or not. Furthermore, the air passing through the second heater zone 220 may flow through the rear vent door 41 to the rear seat vent 40 and may be discharged to the rear seat.

According to another embodiment of the present disclosure, when the interior temperature at the other end of the front seat is lower than the set temperature at the other end of the front seat, which is stored in the controller 300, and the interior temperature at the other end of the rear seat is lower than the set temperature at the other end of the rear seat, which is stored in the controller 300, the controller 300 rotates the second temperature door 131 to open the third flow path 160, and moves the second sub-door 132 so as to open the fourth flow path 170.

In addition, the controller 300 compares the required heat load at the other end of the front seat and the required heat load at the other end of the rear seat, and then partitions the other side of the PTC heater 200 based on output values according to the required heat load at the other end of the front seat and the required heat load at the other end of the rear seat. In one example, the controller 300 may differently adjust the sizes of the respective third and fourth areas of the third heater zone 230 and the fourth heater zone 240 according to the output values of the other end of the front seat and the other end of the rear seat. Furthermore, the controller 300 may compare the output values of the other end of the front seat and the other end of the rear seat and may locate the second temperature door 131 between the third heater zone 230 and the fourth heater zone 240 in response to an output ratio of the output of the other end of the front seat to the output of the other end of the rear seat. In one example, when the output ratio of the output of the other end of the front seat to the output of the other end of the rear seat is 3:7, the second temperature door 131 may be rotated to a position at which a ratio of a height of the third heater zone 230 to a height of the fourth heater zone 240 is 3:7 in the vehicle height direction on the other side of the PTC heater 200.

Therefore, the air passing through the third heater zone 230 is discharged to the other side of the front seat, and the air passing through the fourth heater zone 240 flows to the other side of the rear seat.

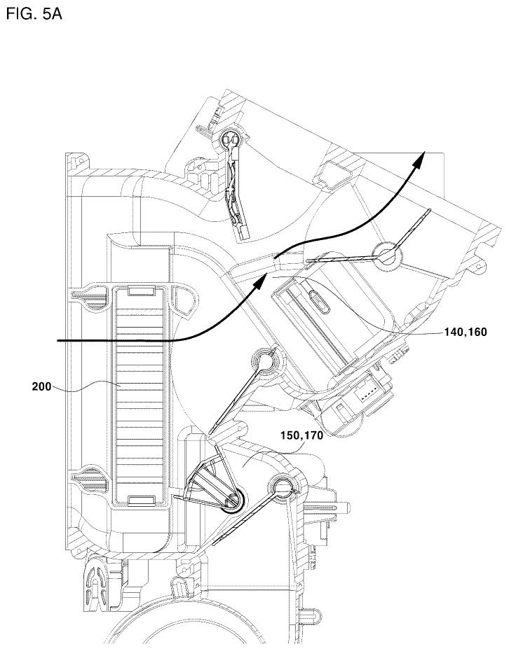

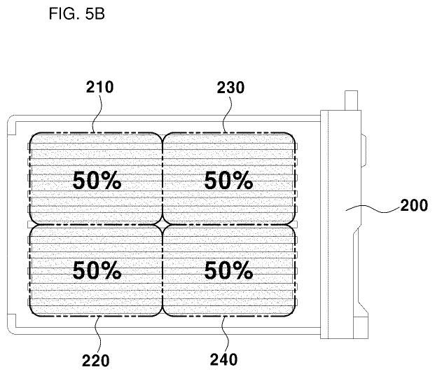

FIG. 5A is a view showing an operation mechanism in which air at the rear end of the PTC heater 200 is discharged to the front seat. FIG. 5B is a view showing the output of the PTC heater 200 when the air at the rear end of the PTC heater 200 is discharged to the front seat.

According to the embodiment of the present disclosure, when the interior temperature at one end of the front seat is lower than the set temperature at one end of the front seat, which is stored in the controller 300, and the interior temperature at one end of the rear seat is higher than the set temperature at one end of the rear seat, which is stored in the controller 300, the controller 300 moves the first temperature door 121 to open the first flow path 140 and closes the first sub-door 122 to block the second flow path 150. In addition, the controller 300 closes the rear vent door 41 in conjunction with the aforementioned operation.

At this time, when the first temperature door 121 is located farthest from the rib 180, the area of the first heater zone 210 gradually becomes large. When the first temperature door 121 is rotated and comes into contact with the rear end surface of the air-conditioning case 100, one side of the PTC heater 200 may be formed of only the first heater zone 210, or may be formed of the first heater zone 210 and the second heater zone 220. Furthermore, when one side of the PTC heater 200 is formed of the first heater zone 210 and the second heater zone 220, the first area of the first heater zone 210 is formed to be larger than the second area of the second heater zone 220.

Here, when only the first heater zone 210 is formed, the controller 300 applies a signal to the first heater zone 210 so as to generate an output according to the required heat load at one end of the front seat. Furthermore, when the first heater zone 210 and the second heater zone 220 are formed, the controller 300 applies a signal to each of the first heater zone 210 and the second heater zone 220 so as to generate different outputs in the first heater zone 210 and the second heater zone 220 according to the required heat load at one end of the front seat. In one example, the controller 300 applies a signal so that the output of the first heater zone 210 is relatively greater than the output of the second heater zone 220.

Through this configuration, the air passing through the rear end of the PTC heater 200 may flow to the first flow path 140 and may be discharged to the front seat.

According to another embodiment of the present disclosure, when the interior temperature at the other side of the front seat is lower than the set temperature at the other side of the front seat, which is stored in the controller 300, and the interior temperature at the other side of the rear seat is higher than the set temperature at the other side of the rear seat, which is stored in the controller 300, the controller 300 rotates the second temperature door 131 to fluidly connect the third flow path 160 to the third heater zone 230, and rotates the second sub-door 132 to block the flow of air through the fourth flow path 170.

In this case, when the second temperature door 131 is rotated in a direction toward the second sub-door 132, the third area of the third heater zone 230 gradually becomes large. When the second temperature door 131 is rotated and is located closest to the second sub-door 132, the other side of the PTC heater 200 may be formed only of the third heater zone 230, or may be formed of the third heater zone 230 and the fourth heater zone 240. Here, the third area of the third heater zone 230 is formed to be larger than the area of the fourth heater zone 240.

Additionally, when only the third heater zone 230 is formed, the controller 300 applies a signal to the third heater zone 230 so as to generate an output according to the required heat load at the other end of the front seat. Furthermore, when the other side of the PTC heater 200 is formed of the third heater zone 230 and the fourth heater zone 240, the third heater zone 230 and the fourth heater zone 240 may be driven such that different outputs are respectively generated in the third heater zone 230 and the fourth heater zone 240. Through this configuration, the air passing through the third heater zone 230 and the fourth heater zone 240 or only the air passing through the third heater zone 230 may be simultaneously discharged to the other end of the front seat.

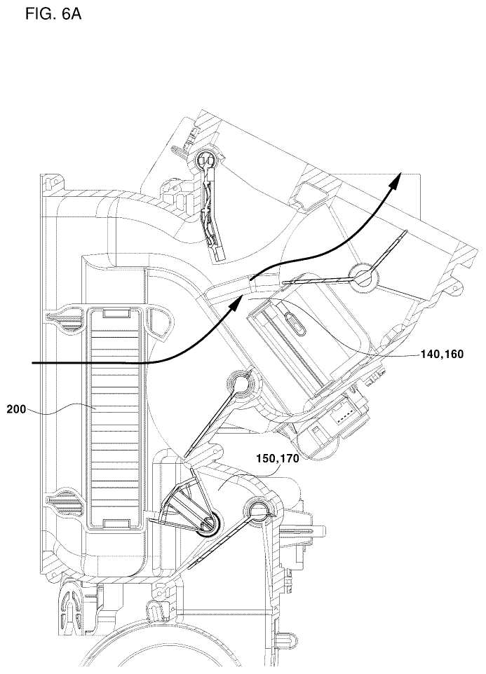

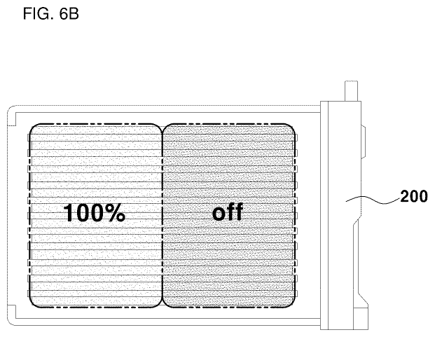

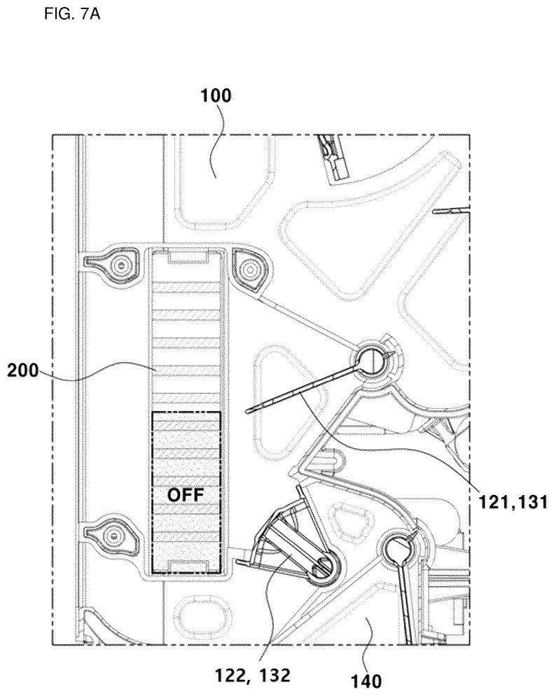

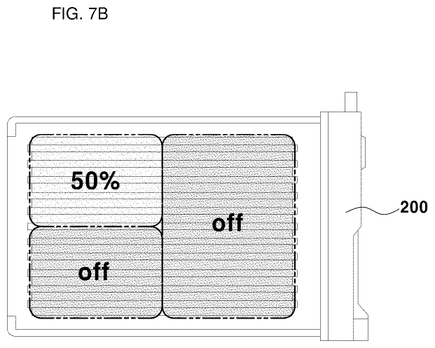

FIG. 6A is a view showing an operation mechanism in which the required heat load at one end of the front seat is in the maximum state in the drive-only mode. FIG. 6B is a view showing the output of the PTC heater 200 according to the operation mechanism. FIG. 7A is a view showing an operation mechanism in the drive-only mode when a part of the first flow path 140 is opened. FIG. 7B is a view showing the output of the PTC heater 200 according to the operation mechanism.

Referring to FIGS. 6A-7B, according to the embodiment of the present disclosure, when a control mode corresponds to the drive-only mode, the controller 300 opens the first temperature door 121 so as to open the first flow path 140, and closes the second temperature door 131 so as to close the second flow path 150. In one example, the first temperature door 121 is rotated to completely open the first flow path 140.

Furthermore, when the interior temperature at one end of the front seat is lower than the set temperature at one end of the front seat, which is stored in the controller 300, the controller 300 controls the output of one side of the PTC heater 200 in response to the required heat load at one end of the front seat.

As shown in FIGS. 6A and 6B, when a difference between the interior temperature at one end of the front seat and the set temperature at one end of the front seat, which is stored in the controller 300, is greater than a predetermined range, the controller 300 controls the output of the first heater zone 210. In this case, the controller 300 may control the output of the first heater zone so as to generate the maximum output. In addition, the controller 300 cuts off power to the other side of the PTC heater 200 so as to satisfy the required heat load through a part of the output of the PTC heaters 200. Here, air passing through the first heater zone 210 may be discharged only to the front seat.

As shown in FIGS. 7A and 7B, according to another embodiment of the present disclosure, when a difference between the interior temperature at one end of the front seat and the set temperature at one end of the front seat, which is stored in the controller 300, is within a predetermined range, the controller 300 partitions one side of the PTC heater 200 into the first heater zone 210 and the second heater zone 220 in response to the required heat load at one end of the front seat.

After partitioning one side of the PTC heater 200 into the first heater zone 210 and the second heater zone 220, the controller 300 applies a signal such that an output is generated only in the first heater zone 210 in response to the required heat load. At the same time, the controller 300 cuts off power to the second heater zone 220, the third heater zone 230, and the fourth heater zone 240.

That is to say, when the air is discharged only to the front seat, the controller 300 partitions one side of the PTC heater 200 into the first heater zone 210 to which power is supplied and the second heater zone 220 to which power is not supplied according to the required heat load at one end of the front seat. In addition, the controller 300 rotates, in response thereto, the first temperature door 121 to locate the same at a boundary between the first heater zone 210 and the second heater zone 220.

Therefore, the air introduced into the PTC heater 200 may pass through the first heater zone 210 and may be discharged to the front seat through the first flow path 140.

In summary, according to the present disclosure, the controller 300 may determine or calculate the required heat load for each zone to follow the corresponding set temperature in each zone by comparing each interior temperature with a corresponding one of the set temperatures of the four zones. The controller 200 may also independently vary first to fourth areas of each of the respective first heater zone 210 to the fourth heater zone 240 according to the required heat load. The controller 300 may also independently control each of the first heater zone 210 to the fourth heater zone 240 so as to apply an output signal corresponding to each required heat load.

As should be apparent from the above description, the present disclosure may achieve the following effects by the configuration, combination, and use relationship described in the embodiments.

First, a heater output area and a heater output amount are adjusted by an opening degree of a temperature door. This has an effect of increasing flexibility of an air-conditioning system and efficiently controlling energy consumption.

Second, the heater output area is precisely controlled by adjusting the opening degree of the temperature door. This has an effect of increasing passenger comfort and improving energy efficiency of the air-conditioning system.

The technical concepts of the present disclosure have been described in detail with reference to various embodiments thereof. However, the technical concepts and embodiments of the present disclosure may be used in various other combinations, modifications, and environments. In other words, it should be appreciated by those having ordinary skill in the art that changes may be made in the disclosed embodiments without departing from the principles and spirit of the disclosure, the scope of which is defined in the appended claims and equivalents thereto. The embodiments describe examples to implement the technical ideas of the present disclosure. Various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A vehicle air conditioner comprising:
an air-conditioning case;
a positive temperature coefficient (PTC) heater located inside the air-conditioning case;
a partition wall partitioning an area of a rear end of the PTC heater;
a first door unit located on one side of the partition wall;
a second door unit adjacent to the first door unit, the second door unit being located on another side of the partition wall; and
a controller,
wherein the PTC heater includes
a first heater zone located in a first area facing an upper end of the first door unit,
a second heater zone located in a second area facing a lower end of the first door unit,
a third heater zone located in a third area facing an upper end of the second door unit, and
a fourth heater zone located in a fourth area facing a lower end of the second door unit, and
wherein the controller is configured to
control an opening degree of each of the first door unit and the second door unit so as to follow a set temperature in each of the first to fourth areas, and
independently drive each of the first to fourth heater zones in response to the opening degree.

2. The vehicle air conditioner of claim 1, wherein the controller is configured to:
determine, based on a difference between an actual temperature and the set temperature, a required heat load corresponding to each of the first to fourth heater zones; and
vary, in response to the required heat loads, a size of at least one of the first to fourth areas of the corresponding first to fourth heater zones.

3. The vehicle air conditioner of claim 2, wherein, in response to the required heat loads in the respective first to fourth heater zones, the controller is configured to drive each of the first to fourth heater zones so as to generate independent outputs in the respective first to fourth heater zones.

4. The vehicle air conditioner of claim 2, wherein the controller is configured to:
vary the first and second areas of the corresponding first and second heater zones in response to the respective required heat loads at the one end of the front seat and the one end of the rear seat; and
independently control the respective outputs of the first heater zone and the second heater zone in response to the respective required heat loads.

5. The vehicle air conditioner of claim 2, wherein the controller is configured to:
vary the third and fourth areas of the corresponding third and fourth heater zones in response to the respective required heat loads at the other end of the front seat and the other end of the rear seat; and
control the respective outputs of the third heater zone and the fourth heater zone in response to the respective required heat loads.

6. The vehicle air conditioner of claim 1, wherein the air-conditioning case comprises:
a first flow path located facing the first heater zone, the first flow path being fluidly connected to one end of a front seat;
a second flow path located facing the second heater zone, the second flow path being fluidly connected to one end of a rear seat;
a third flow path located facing the third heater zone, the third flow path being fluidly connected to another end of the front seat; and
a fourth flow path located facing the fourth heater zone, the fourth flow path being fluidly connected to another end of the rear seat.

7. The vehicle air conditioner of claim 6, wherein the controller is configured to:
move a first temperature door of the first door unit so as to close the first flow path when an interior temperature exceeds the set temperature at the one end of the front seat; and
move the first temperature door so as to open the first flow path when the interior temperature is equal to or lower than the set temperature at the one end of the front seat.

8. The vehicle air conditioner of claim 6, wherein the controller is configured to:
move a second temperature door of the second door unit so as to close the third flow path when an interior temperature exceeds the set temperature at the other end of the front seat; and
move the second temperature door so as to open the third flow path when the interior temperature is equal to or lower than the set temperature at the other end of the front seat.

9. The vehicle air conditioner of claim 6, wherein the first door unit comprises:
a first temperature door located adjacent to an upper end of the one side of the partition wall; and
a first sub-door located below the first temperature door, the first sub-door being located adjacent to a lower end of the one side of the partition wall.

10. The vehicle air conditioner of claim 9, wherein:
the first flow path is fluidly connected to the first heater zone when the controller opens the first temperature door and is blocked when the controller closes the first temperature door; and
the second flow path is fluidly connected to the second heater zone when the controller opens the first sub-door and is blocked when the controller closes the first sub-door.

11. The vehicle air conditioner of claim 9, wherein the controller is configured to:
move the first sub-door so as to open the second flow path when the interior temperature is lower than the set temperature at the one end of the rear seat; and
move the first sub-door so as to close the second flow path when the interior temperature exceeds the set temperature at the one end of the rear seat.

12. The vehicle air conditioner of claim 9, wherein, when air is discharged only to the one end of the front seat, the controller is configured to:
move the first temperature door so as to open the first flow path; and
move the first sub-door so as to close the second flow path.

13. The vehicle air conditioner of claim 12, wherein, when the interior temperature is lower than the set temperature at the one end of the front seat, the controller is configured to:
vary the size of each of the first and second areas of the corresponding first and second heater zones in response to the required heat load at the one end of the front seat;
control the output of the first heater zone; and
cut off power to the second heater zone.

14. The vehicle air conditioner of claim 6, wherein the second door unit comprises:
a second temperature door located adjacent to an upper end of the other side of the partition wall; and
a second sub-door located below the second temperature door, the second sub-door being located adjacent to a lower end of the other side of the partition wall.

15. The vehicle air conditioner of claim 14, wherein:
the third flow path is fluidly connected to the third heater zone when the controller opens the second temperature door and is blocked when the controller closes the second temperature door; and
the fourth flow path is fluidly connected to the fourth heater zone when the controller opens the second sub-doo, and is blocked when the controller closes the second sub-door.

16. The vehicle air conditioner of claim 14, wherein the controller is configured to:
move the second sub-door so as to open the fourth flow path when the interior temperature is lower than the set temperature at the other end of the rear seat; and
move the second sub-door so as to close the fourth flow path when the interior temperature exceeds the set temperature at the other end of the rear seat.
